(19) United States
(12) Patent Application Publication
(10) Pub. No.: US 2007/0059224 A1
(43) Pub. Date: Mar. 15, 2007

(54) VIRTUAL SORBENT BED SYSTEMS AND METHODS OF USING SAME

(76) Inventor: Herek L. Clack, Chicago, IL (US)

Correspondence Address: BELL, BOYD & LLOYD, LLP, P.O. Box 1135, CHICAGO, IL, 60690, US

(21) Appl. No.: 11/533,688

(22) Filed: Sep. 20, 2006

Related U.S. Application Data
(63) Continuation-in-part of application No. 11/140,832, filed on May 31, 2005.
(60) Provisional application No. 60/576,334, filed on Jun. 1, 2004.

(51) Int. Cl. B01J 19/08; B01J 19/12

(52) U.S. Cl. 422/186.01

(57) ABSTRACT

Virtual sorbent bed systems and methods for receiving contaminants from a waste stream are presented. In an embodiment, the system comprises at least one outlet for introducing a sorbent material into a gas stream and one or more charged AC electrodes sequentially followed by at least a first charged DC electrode and at least a second charged DC electrode. The charged AC electrode generates a first electric field that imparts a motion to the material. The first charged DC electrode and the second charged DC electrode cooperatively generate a second electric field that imparts a drift velocity to the material.

### CROSS REFERENCE TO RELATED APPLICATIONS

This patent application is continuation-in-part of U.S. patent application Ser. No. 11/140,832 filed on May 31, 2005, which claims the benefit of U.S. Provisional Patent Application No. 60/576,334, filed on Jun. 1, 2004, the entire disclosures of which are herein incorporated by reference.

### BACKGROUND OF THE INVENTION

The present invention relates generally to chemical technologies. More specifically, the present invention relates to virtual sorbent bed systems and methods of using same.

Mercury has been recognized as a serious pollutant of concern due to its toxic and bioaccumulative properties. Trace amounts of mercury can be magnified up the aquatic food chain hundreds of thousands of times, posing a potential risk to humans and wildlife that consume contaminated fish. In human beings, mercury adversely affects the central nervous system—the brain and spinal cord—posing a significant risk to developing children.

The U.S. EPA has created new regulations for the emission of mercury embodied in the Clean Air Mercury Rule issued in March, 2005. The new mercury emissions regulations most directly affect municipal incinerators, medical-waste incinerators, and coal-burning boilers of electric utilities. These are the largest sources of mercury emissions in the U.S., each accounting for roughly one-third of the total amount of mercury released in the U.S.

Municipal and medical-waste incinerators have specific characteristics that are conducive to controlling mercury emissions. Generally, the exhaust streams of both municipal and medical-waste incinerators are small and contain relatively high concentrations of mercury. These characteristics allow conventional exhaust cleaning methods to effectively remove mercury. In particular, 70% of the mercury in the exhaust of municipal and medical-waste incinerators is in the form of mercuric chloride (HgCl₂), which is easily removed by wet scrubbing and dry absorption processes. The characteristics of municipal and medical-waste incinerators allow mercuric chloride (HgCl₂) to form. Because plastic comprises a large percentage of the wastes destroyed in incinerators, an ample source of chlorine is available for the high temperature oxidation of elemental mercury (Hg⁰) to mercuric chloride (HgCl₂).

Compared to municipal and medical-waste incinerators, the removal of mercury from the exhaust of coal-burning boilers of electrical utilities is more complex. Coal contains only trace amounts of mercury, 1-15 parts per billion, by weight. However, although coal contains only trace amounts of mercury, in 1997 combustion of over 900 million tons of coal released 50 tons of mercury into the environment. Compared to municipal and medical-waste incinerators, the typical exhaust gas stream from a coal-fired boiler is very large. The mercury in the exhaust of coal-burning boilers can exist in both physical forms (vapor and condensed) and in both oxidation sates (elemental (Hg⁰) and oxidized (HgCl₂)). The total concentration of mercury and its distribution among the various forms and oxidation states initially depends on the details of the combustion process and the rank of the origin of the coal. However, these distributions are dynamic, shifting with changing gas temperature and gas composition throughout the exhaust train. As no two coal-fired boilers have identical configurations, the evolution of mercury in the post-combustion environment is virtually unique to each facility. Consequently, controlling mercury emissions from coal combustion is extremely difficult due to the large degree of variability and uncertainty in the phase, state, and concentration of mercury emitted from different facilities.

The electric utility industry is largely unprepared to reduce mercury emissions. There is no commercial technology that is currently available for controlling mercury emissions from coal-fired boilers. Prior art attempts at mercury emission control technologies, such as U.S. Pat. No. 6,699,440 to Vermeulen, focus on fixed bed adsorption, requiring that the mercury-laden flue gas pass through a layer of powdered sorbent deposited on a fabric filter. As 90% of coal-fired boilers do not have such fabric filers installed, such an approach constitutes a prohibitively expensive retrofit for many operators. Installing fabric filters would also create increased pressure drop in the waste gas stream, entailing additional costs to install downstream induced draft fans, as well as reinforcement of upstream ductwork to support the greater pressure differential. These issues create a high projected cost for reducing mercury emissions. Under contemporary pollution control technology, a 90% reduction in mercury emissions is projected to cost the electric utility industry from $6 billion to $15 billion annually.

It is therefore desirable to provide an efficient and cost-effective technology for removing heavy metals and other chemicals from waste gas streams.

### SUMMARY OF THE INVENTION

The present invention generally relates to virtual sorbent bed systems that provide for an efficient and economical way for receiving (e.g. adsorbing, absorbing, contacting, mass transferring) various compounds from waste gas streams. In an embodiment, the system comprises at least one outlet for introducing one or more materials into a gas stream and one or more charged AC electrodes sequentially followed by at least a first charged DC electrode and at least a second charged DC electrode. The charged AC electrodes generate a first electric field that imparts a motion to the material. The first charged DC electrode and the second charged DC electrode cooperatively generate a second electric field that imparts a drift velocity to the material.

In an embodiment, the material is electrically charged prior to entering the gas stream.

In an embodiment, the first charged DC electrode and the second charged DC electrode have a different voltage.

In an embodiment, the second charged DC electrode has voltage of 0 and is grounded.

In an embodiment, the second charged DC electrode comprises a plate so constructed and arranged for collecting the material.

In an embodiment, each charged AC electrode is oriented substantially peripheral to the gas stream and normal to the flow of the gas stream. For example, each charged AC electrode generates an electric field that imparts motion to the material.

In an embodiment, the at least one outlet comprises a plurality of outlets that are stacked.

In an embodiment, the at least one outlet comprises a plurality of outlets that are in series along the gas stream.

In an embodiment, wherein the motion generated by the AC electrode is periodic.

In an embodiment, the material is selected from the group consisting of a solid material, a liquid material, a powdered material, an aerosol, a sorbent, a catalyst and combinations thereof.

In an embodiment, the material is capable of receiving a contaminant from the gas stream.

In an embodiment, the outlet is located upstream of the charged AC electrode.

In an embodiment, the outlet is constructed and arranged for injecting a liquid into the gas stream.

In an embodiment, the injected liquid is selected from the group consisting of an ammonia solution, a urea solution, an aerosol and combinations thereof.

In an embodiment, the material is capable of receiving a plurality of contaminants from the gas stream.

In an embodiment, the material is electrically charged prior to entering the gas stream.

In another embodiment, the present invention provides a system comprising: at least one outlet for introducing a material into a gas stream, wherein the material is capable of receiving a contaminant from the gas stream; and at least one charged AC electrode, the charged AC electrode generating a second electric field that imparts additional motion to the material.

In an embodiment, the charged AC electrode is sequentially followed by one or more filters.

In an embodiment, the filter is any suitable device that can remove a solid or liquid material such as, for example, a fabric filter (e.g. baghouse filter), a cyclone, a wet scrubber and combinations thereof.

In an alternative embodiment, the present invention provides a system for manipulating a material. For example, the system comprises at least one charged AC electrode sequentially followed by at least a first charged DC electrode and at least a second charged DC electrode. The charged AC electrode generates a first electric field that imparts a motion to the material. The first charged DC electrode and the second charged DC electrode cooperatively generate a second electric field that imparts a drift velocity to the material.

In another embodiment, the present invention provides a virtual sorbent bed system for removing a contaminant from a gas stream. In this embodiment, the system comprises: a plurality of charged AC electrodes oriented substantially peripheral to the gas stream and normal to the flow of the gas stream. The plurality of charged AC electrodes generate a first electric field that imparts three-dimensional motion to the contaminant. The system further comprises a positively charged DC electrode located downstream of the AC electrodes. The positively charged DC outlets are oriented substantially peripheral to the gas stream and normal to the flow of the gas stream. The system also comprises a negatively charged DC electrode located downstream of the positively charged DC electrode and oriented substantially peripheral to the gas stream and normal to the flow of the gas stream. The positively charged DC electrode and the negatively charged DC electrode cooperatively generate a second electric field that imparts a drift velocity to the contaminant.

In an alternative embodiment, the present invention provides a method for receiving a contaminant from a gas stream. For example, the method comprises: introducing a material into the gas stream through at least one outlet, wherein the material is capable of receiving the contaminant from the gas stream; generating a first electric field from at least one charged AC electrode, wherein the first electric field imparts motion to the material; and generating a second electric field from at least a first charged DC electrode and at least a second charged DC electrode. The second electric field imparts a drift velocity to the material. The first charged DC electrode and the second charged DC electrode are located downstream of the charged AC electrode.

In an embodiment, the method further comprises receiving and collecting the material after the material has removed the contaminant from the gas stream.

In an embodiment of the method, the material is electrically charged prior to entering the gas stream.

In an embodiment of the method, the material is selected from the group consisting of a solid material, a liquid material, a powdered material, an aerosol, a sorbent, a catalyst and combinations thereof.

In yet another embodiment, the present invention provides a method for receiving a contaminant from a gas stream. In this embodiment, the method comprises: introducing a material into the gas stream through at least one outlet, wherein the material is capable of receiving the contaminant from the gas stream; generating a first electric field from at least one charged AC electrode, wherein the first electric field imparts motion to the material; and providing a filter to receive or collect the material.

An advantage of the present invention is to provide a more cost effective and efficient system for receiving or removing contaminants from a waste gas stream.

Another advantage of the present invention is to provide an efficient system for detecting biological contaminants in the air.

Still another advantage of the present invention is to provide a system for reusing sorbent thereby obtaining a cost-savings.

Additional features and advantages of the present invention are described in, and will be apparent from, the following Detailed Description of the Invention and the figures.

### BRIEF DESCRIPTION OF THE FIGURES

FIG. 1A is a schematic illustrating an end view of the virtual sorbent bed system in one embodiment of the present invention.

FIG. 1B is a schematic illustrating a top or plan view of the virtual sorbent bed system in one embodiment of the present invention.

FIG. 1C is a schematic illustrating a top or plan view of the virtual sorbent bed system in an alternative embodiment of the present invention.

FIG. 2 is a graph illustrating the comparison of the particle trajectories and normalized swept volume for particles subjected to hydrodynamic drag, electrostatic drift and electrodynamic oscillation.

FIG. 3 is a schematic illustrating a generic representation of a particle-laden channel flow between two plate electrodes of an electrostatic precipitator (ESP).

FIG. 4 is a graph illustrating model predictions for mercury removal efficiency in a virtual sorbent bed system at two different operating points (A-1 and A-2) as compared to a conventional ESP alone.

FIG. 5 is a graph illustrating is a graph illustrating model predictions for reduction in sorbent usage in a virtual sorbent bed system at two different operating points (A-1 and A-2) as compared to a conventional ESP alone.

### DETAILED DESCRIPTION OF THE INVENTION

The present invention relates to chemical remediation technologies for receiving (e.g. adsorbing, absorbing, contacting, mass transferring) various pollutants from emitted industrial gas streams. More specifically, the present invention relates to virtual sorbent bed (“VSB”) systems and methods of using same. In an embodiment, the VSB system generally comprises electrodes or any suitable electric field generators that produce electric fields (e.g. AC and DC) which manipulate the movement of a charged suspension of a sorbent powder to separate contaminants such as heavy metals and other chemicals from waste gas streams.

Sorbent beds may be, for example, dense, charged suspensions of a sorbent (solid or liquid). The sorbent can be any suitable material, such as powdered activated carbon, that is capable of being suspended or movable in gas streams and capable of receiving a contaminant such as, for example, heavy metals and chemicals from gas streams. Receiving a contaminant may refer to absorbing, adsorbing or contacting the contaminant or may refer to the surrounding conditions (e.g. air pressure, air currents, temperature, material or contaminant motion) within the gas stream that cause or induce mass transfer from the gas phase to the solid or liquid phase of the material 40.

The dense, charged suspension can be bounded by mutually orthogonal AC and DC electric fields. It has been found that the application of electrodynamic (AC) and electrostatic (DC) forces on the particles in the suspension causes them to trace sinusoidal paths through the flowing gas. The continuous, sinusoidal relative motion between the suspended particles and flowing gas greatly enhances gas-particle mass transfer as compared to the diffusive mass transfer that would occur within a suspension having no net charge. Yet, because the particles are suspended within the flowing gas, they induce effectively no fluid pressure drop.

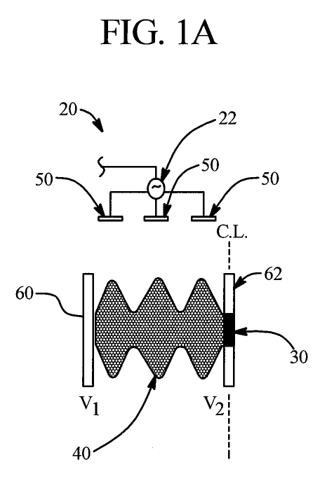

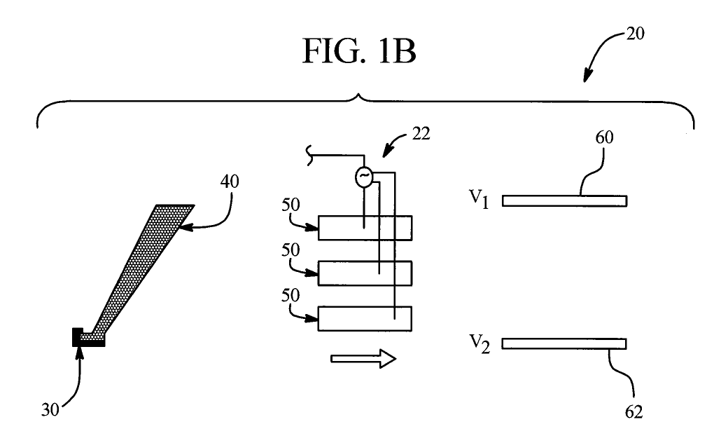

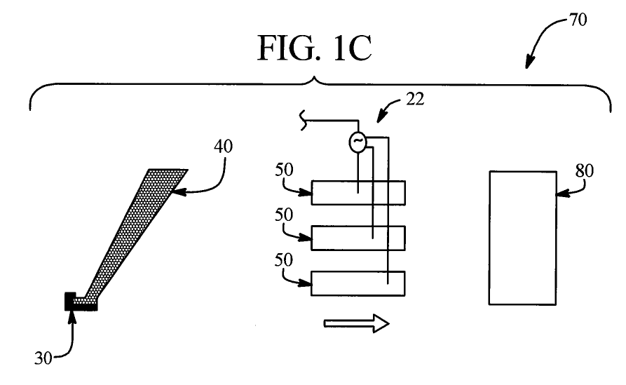

In an embodiment illustrated in FIGS. 1A-1B, the VSB system 20 comprises at least one outlet 30 for introducing one or more materials 40 into a gas (e.g. air) stream and one or more charged AC electrodes 50 sequentially followed by at least a first charged DC electrode 60 and at least a second charged DC electrode 62. FIG. 1A shows a schematic of an end view of one general embodiment of the VSB system 20 adapted for removing trace concentrations of mercury from coal combustion exhaust. FIGS. 1B and 1C show a schematic of a top or plan view of alternative embodiments of the VSB system 20. The arrow represents the direction of the airflow in FIGS. 1B and 1C. It should be appreciated that the first and second DC electrodes can be any suitable distance after the AC electrode.

Suspended and/or charged sorbent or material 40 issues into the mercury-laden exhaust stream from at least one injector or outlet 30. The material 40 may comprise, for example, a solid powdered sorbent or a liquid material. The material 40 may be positively or negatively charged or not charged at all. It should be appreciated that the air flow can take place in a tunnel or other suitable structure (not shown) for directing contaminated air through the AC and DC electrodes.

The charged AC electrodes 50 generate a first electric field that imparts a motion to the material 40. The first charged DC electrode 60 and the second charged DC electrode 62 cooperatively generate a second electric field that imparts a drift velocity to the material 40. The material 40 can then collect or accumulate on one or more of the charged DC electrodes as a means of removing the material 40 containing contaminant from the gas stream.

In another embodiment, the second charged DC electrode 62 can comprise a charged plate constructed and arranged to receive or collect the material 40. For example, before the material 40 in the gas stream leaves the VSB system 20, some or all of it collects or amasses on the plate because of the voltage differential between the first charged DC electrode 60 and the second charged DC electrode 62. The material 40 can then collect or accumulate on one or more of the charged DC electrodes as a means of removing the material from the gas stream.

In an embodiment, the VSB system 20 may have a voltage source 22 connected to ground and connected to an amplitude and frequency controller (not shown). The size, shape, and configuration of the controller and the voltage source 22 can be any suitable for use. The amplitude and frequency controller can be connected to one or more AC electrodes 50.

The charged AC electrodes 50 can be oriented longitudinally parallel to the flow of the gas stream, with the leading edge of the AC electrodes on the same plane as the following edge of the charged injectors or outlets 30, on a plane perpendicular to the flow of the gas stream. The AC electrodes 50 can be connected to the interior housing of a gas stream containment.

Each charged AC electrode 50 is individually capable of generating a an electric field that imparts the motion to the material 40. For example, the AC electrodes 50 create an electric field of frequency and period as regulated by the amplitude and frequency controller 114 to facilitate the mass transfer between the material 40 and the trace gas species to be removed from the gas stream. The AC electrodes 50 can be made of any suitable conductive material such as, but not limited to, copper, aluminum, or steel. Preferably, the AC electrodes 50 may have a curved cross-section along the short length only, convex toward the gas flow; however other shapes can be used.

The charged AC electrodes 50 generate AC electric fields that can impose a sinusoidally varying electrodynamic drift velocity that is orthogonal to the gas velocity. An effect of this electric field is to impart a high degree of relative motion (e.g. two and three dimensional motion) between the gas and the particulate phases. It should be appreciated that the shape of the suspended material 40 in the figures are for illustrative purposes only and are not intended to represent the actual motion of the suspended material 40.

The first charged DC electrode 60 and the second charged DC electrode 62 have a different voltage thereby forming a direct current field between the two charged sources. This field induces a constant electrostatic drift velocity, normal to the gas velocity, drawing the charged material 40 through and across the mercury-laden gas stream. In another embodiment, the first charged DC electrode could have a positive or negative voltage and the second charged DC electrode could be the ground (i.e. 0 voltage). It should be appreciated that any suitable combination of voltages/ground can be used for the first and second DC electrodes to generate a potential difference and a direct current field between the electrodes.

In another embodiment illustrated in FIG. 1C, the present invention provides a system 70 comprising: at least one outlet 30 for introducing a material 40 into a gas stream, wherein the material 40 is capable of receiving a contaminant from the gas stream; and one or more charged AC electrodes 50. The charged AC electrodes 50 generate a second electric field that imparts additional motion to the material 40. Further, the charged AC electrodes 50 can be sequentially followed by one or more filters 80 to remove the material 40. For example, the filter can be any suitable device known to the skilled artisan that removes a solid or liquid material such as a fabric filter (e.g. baghouse filter), a cyclone, a wet scrubber and combinations thereof.

In alternative embodiments, the VSB system 20 can comprise one or more openings, passages, vents, injectors or outlets 30 for introducing the sorbent or material 40 into the gas stream, wherein the material 40 is capable of receiving a contaminant from the gas stream. The electric fields generated by the electrodes may then facilitate the mass transfer between a charged powdered solid material such as activated carbon and trace amounts of gas species within the gas stream. Preferably, the outlet 30 injects the charged material 40 into the gas stream in a sheet-like manner so that the charged material covers a large volume in the gas stream.

It should be appreciated that the material 40 may be any solid or liquid material capable of receiving a contaminant from a waste gas stream. For example, the material 40 can be a solid material such as a sorbent, catalyst or combinations thereof. The sorbent can be powdered material such as powdered activated carbon. Further, the contaminants in the gas stream may undergo reactions by contacting the catalysts. In addition, the material 40 may be capable of receiving a plurality of contaminants from the gas stream.

In an embodiment, the outlet of the VSB system 20 may be capable of injecting one or more liquids into the gas stream. For example, the outlet or outlets may be injectors or any suitable devices for injecting a liquid into the gas stream. The liquid can be dispersed, for example, as an aerosol. Preferably, the injector or injectors for injecting liquid are located sufficiently upstream of the charged AC electrode at a distance sufficient to assure a largely dispersion and uniform liquid distribution within the gas stream by the time the liquid in the gas stream reaches the charged electrodes. For example, the injected liquid can be an ammonia solution, a urea solution, an aerosol and combinations thereof.

In further embodiments, the present invention provides a method for receiving contaminants in a gas stream using the VSB system 20 comprising: a) introducing a material into the gas stream through at least one outlet, wherein the material is capable of receiving the contaminant from the gas stream; and b) generating a first electric field from at least one charged AC electrode, wherein the first electric field imparts motion to the material; and c) generating a second electric field from at least a first charged DC electrode and at least a second charged DC electrode, the second electric field imparting a drift velocity to the material. The first charged DC electrode and the second charged DC electrode are located downstream of the charged AC electrode. In addition to or instead of the first and second charged DC electrode, a filter can be provided for receiving, accumulating and/or collecting the material to remove the contaminant from the gas stream.

In another embodiment, the VSB system 20 can be paired in series with additional air purification processes. This would allow the injected sorbent and fly ash to be collected separately so that the former can be recycled and regenerated while also preserving the market for fly ash. In an embodiment, the VSB system 20 is highly flexible, allowing it to respond in real time to operational transients, fuel blending, fuel switching, and part-load operation. Unlike fixed sorbent beds formed on fabric filters, the VSB system 20 can be completely idled, becoming a transparent exhaust train component when conditions warrant. Finally, in-flight and fixed bed adsorption for mercury control need not be mutually exclusive. Injecting a powdered sorbent to establish a downstream fixed sorbent bed necessarily involves the creation of a gas-sorbent suspension. Consequently, even where fixed bed adsorption is favored, in-flight adsorption can augment the performance of the fixed bed and reduce rates of sorbent usage.

Theoretically, the VSB system 20 utilizes, for example, a gas solid mass transfer process that exploits the beneficial mass transfer characteristics of suspensions. The relatively small temporal and spatial scales of dense and/or turbulent suspensions complicate characterization of their behavior. The VSB system 20, by virtue of its exceptional control over the dispersed phase exerted by the dual electric fields, allows existing mass transfer coefficients and correlations to be extended to dense and/or turbulent suspensions.

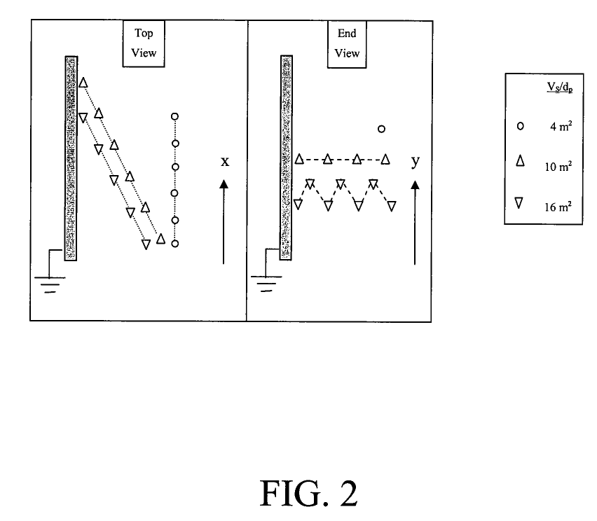

FIG. 2 illustrates the effect of gas-particle relative motion on mass transfer to the particulate phase. FIG. 2 depicts trajectories of sorbent particles under three conditions: 1) subjected to hydrodynamic forces alone 12; 2) subjected to both hydrodynamic and electrostatic forces 14; and 3) subjected to hydrodynamic, electrostatic, and electrodynamic forces combined 16. The superposition of hydrodynamic, electrostatic, and electrodynamic forces causes the particles to trace the longest paths through the gas. Defining swept volume V_{S} as the product of particle path length and particle cross-sectional area, for a specified particle diameter, the value of V_{S} will increase as the particle path length increases. Defining a normalized swept volume V_{S}/dₚ (where dₚ is the particle diameter) provides a means for comparing the mass transfer enhancement exhibited by particles of different sizes as they are subjected to hydrodynamic, electrostatic, and electrodynamic forces.

In FIG. 2, for a representative particle size, charge, and gas velocity, the normalized swept volume V_{S}/dₚ increases from 4 m² for hydrodynamic forces alone to 16 m² when hydrodynamic, electrostatic, and electrodynamic forces are superposed, a four-fold increase. Assuming that gas-particle mass transfer scales with V_{S}/dₚ, these results suggest that virtual sorbent beds should achieve four times greater mass transfer than uncharged suspensions. The differences in mass transfer are even more striking if they are considered relative to a coordinate system moving with the gas. Such a coordinate system is more appropriate than an inertial coordinate system for considering gas-particle mass transfer. If in this coordinate system, a modified swept volume (V*_{S}) and modified normalized swept volume (V*_{S}/dₚ) are defined, then the values of V*_{S}/dₚ are 0 m² for hydrodynamic forces alone, 6 m² for both hydrodynamic and electrostatic forces, and 12 m² for combined hydrodynamic/electrostatic/electrodynamic forces. In summary, imposing electrostatic/electrodynamic forces produces a substantial performance enhancement for mass transfer over uncharged suspensions.

In alternative embodiments, the outlet 30 can introduce the charged powdered sorbent as a dense suspension initially contained within a low-velocity planar jet. This approach concentrates the suspension to enhance mass transfer and inhibits turbulent mixing of the sorbent-laden jet with its surroundings, thereby minimizing jet mixing and its associated negative impacts on mass transfer within the sorbent suspensions.

As previously discussed, VSBs exploit the increase in mass, momentum, and heat transfer that occurs between a particle and a gas during particle acceleration. For example, increased momentum transfer between an accelerating particle and the fluid that surrounds it (i.e., fluid-particle drag) is a known fluid dynamic phenomenon, requiring the addition of added mass and Bassett history terms to the steady-state form of the Navier-Stokes equations of fluid motion. Through the Reynolds analogy, fluid transport phenomena often can be extrapolated to mass and energy transfer phenomena.

Performance predictions were developed for the virtual sorbent bed in an embodiment of the present invention based on an analytical model of gas-particle mass transfer during conventional electrostatic precipitation, described in detail below. This analytical model is further described in detail in Clack, H. L., Environmental Science and Technology 40 (12), pp 3929-3933 (2006), which is entirely incorporated herein by reference. This model considers either monodisperse or polydisperse generic particle suspensions entering an electrostatic precipitator (ESP).

For a specified DC electric field strength applied within the ESP, the model calculates as a function of particle size the charge and resulting particle drift velocity. In addition, the model uses the Deutch-Anderson equation to calculate the decrease in the number concentration of particles of a given size, due to their collection on the ESP plate electrodes, as the suspension passes through the ESP. Taken together, these two calculations determine as a function of particle size the slip velocity (and thus the Reynolds number) between a particle and the surrounding gas, as well as the rate of decrease in the number concentration of particles of that size. With the Reynolds number determined as a function of particle size, and assuming all particles to be spherical, the Sherwood number and gas-particle mass transfer rate for each particle size class can be calculated. Thus, taking the gas-particle mass transfer rates and instantaneous number density of each particle size class, the instantaneous sum over all particle size classes yields the total instantaneous gas-particle mass transfer rate as particles are collected during conventional electrostatic precipitation. The virtual sorbent bed technology utilizes an AC electric field to induce oscillatory motion to suspended particles.

It has previously been confirmed numerically, that spherical particles oscillating relative to a gas flow experience much higher rates of gas-particle mass transfer. They have reduced their findings to show that the enhanced rate of mass transfer, represented by greatly increased Sherwood numbers, can be correlated through a parameter involving the frequency of particle oscillation. Thus, by assuming the same frequency of oscillation, the present model of gas-particle mass transfer within an ESP can be modified to predict the increased gas-particle mass transfer rates of a virtual sorbent bed process in which conventional electrostatic precipitation involving a DC electric field is augmented with an AC electric field to induce the necessary oscillatory particle motion.

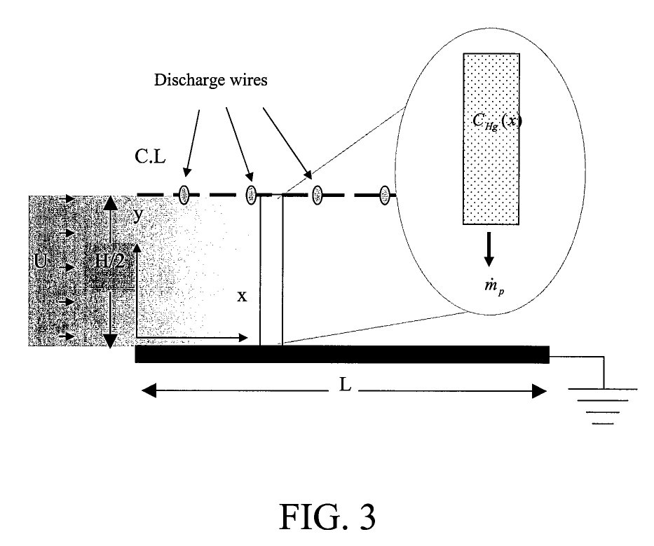

The present model of gas-particle mass transfer within an electrostatic precipitator will now be described in detail. Consider a generic representation of a particle-laden channel flow between two plate electrodes of an ESP (FIG. 3). Although laminar flows have been analyzed in the past, it is generally accepted that both Reynolds number considerations and electrohydrodynamic effects virtually guarantee that flows within industrial ESPs are turbulent. The gas phase is air that nominally enters the channel at 500 K, 1 atm, and 3 m/s containing 4 ppbv of elemental mercury (Hg⁰) (C_{Hg}(x=0)=4 ppbv). The ultra dilute Hg⁰ concentration allows thermodynamic and fluid properties of the mixture to be approximated as those of air, an ideal gas. The width H and stream-wise length L of the channel are 0.5 m and 10 m, respectively, yielding a residence time in the channel of 3.3 seconds and a Reynolds number of 38,800 that exceeds the critical value for turbulent flow.

Spherical particles of diameter dₚ make up the particulate phase of the particle-laden flow, particles whose size distribution is log-normal, represented by eq 1 (13):

$${ND}_{p} ( {d}_{p} ) = \frac{〈 {ND}_{p} 〉}{{( 2 π )}^{1 / 2} {d}_{p} ln {σ}_{g}} exp [ - \frac{{( ln {d}_{p} - ln {d}_{pg} )}^{2}}{2 {ln}^{2} {σ}_{g}} ] \qquad ( 1 )$$

where NDₚ(dₚ) is the particle number density per unit particle diameter (for particle of diameter dₚ) [1/m³-μm], <NDₚ> is the total particle number density over all particles [1/m³], and σ is the geometric standard deviation of the particle size distribution [-]. To facilitate and emphasize gas-particle mass transfer, the particles are treated as perfect Hg⁰ sinks at whose surface the gas-phase Hg⁰ concentration is zero. Although this condition is restrictive and neglects mass transfer resistances associated with adsorption kinetics, intraparticle diffusion, and sorbent capacity, it allows the collection of a polydisperse aerosol within an ESP to be interpreted unambiguously in terms of impacts on gas-particle mass transfer. Requiring the model to isolate gas-particle mass transfer effects allows subsequent consideration of both Hg⁰ adsorption by injected powdered activated carbon (PAC) and Hg⁰ oxidation by native fly ash, as either (or both) is collected within an ESP.

Particle dynamics within the turbulent, particulate-laden channel flow are addressed in a manner similar to that used in developing the Deutsch-Anderson equation for predicting particle collection within an ESP. Specifically, the flow is assumed to be sufficiently turbulent that scalar quantities such as Hg⁰ concentration C_{Hg} and particle number density NDₚ(dₚ) remain uniform in the cross-stream direction (y-direction, FIG. 3), the dispersive nature of the turbulent flow preventing the development of cross-stream gradients. Previous studies have shown through detailed modeling that ESP particle collection efficiency decreases as turbulent diffusivity is reduced from the infinite value assumed in the Deutsch-Anderson equation to finite and more realistic values. Calculated transient response times for the largest particles considered here are generally less than a fraction of a millisecond, implying that on the time scale of turbulent velocity fluctuations the particles are able to maintain the equilibrium between Coulombic and drag forces. Consequently, whereas particle paths are strongly influenced by turbulent velocity fluctuations, the relative velocity between the particle and the gas (i.e., the gas-particle slip velocity) is not. It is the relative velocity between the particle and the gas that governs gas-particle mass transfer.

The terminal electrostatic drift velocity, representing the equilibrium between Coulombic and drag forces, of a particle of diameter dₚ is (eq 2):

$${U}_{es} ( {d}_{p} ) = \frac{n \cdot e E {C}_{c}}{3 π μ {d}_{p}} \qquad ( 2 )$$

where e is the value of an elementary charge, i.e. an electron (4.8e⁻¹⁰ stC); n is the number of elementary charges retained by the particle; E is the electric field strength, a variable in the numerical model [stV/cm]; and μ is the dynamic viscosity of air, a function of temperature in the numerical model [dyn-s/cm²]. C_{c} is the Cunningham slip correction factor for Stokes drag on small particles (eq 3):

$${C}_{c} = 1 + Kn [ 1.257 + 0.4 ( exp ( \frac{- 1.1}{Kn} ) ) ] \qquad ( 3 )$$

where Kn is the Knudsen number, defined as the ratio of molecular mean free path λ to particle diameter dₚ. The molecular mean free path λ varies with pressure and temperature, both variables in the numerical model, as given by eq 4:

$$λ = \frac{\hat{R} T}{\sqrt{2} π {d}_{N2}^{2} {N}_{A} P} \qquad ( 4 )$$

where \hat{R} is the universal gas constant (8.314 kJ/mol-K); T is temperature [K]; d_{N2} is the diameter of an N₂ gas molecule (3.7\dot{A}); N_{A} is Avogadro's number (6.02×10²³ atoms/mole); and P is pressure [kPa].

In an earlier analysis of gas-particle mass transfer within ESPs, the number of elementary charges on a particle was uniformly set at 1% of the maximum possible charge based on particle diameter. The present model provides a more realistic representation of particle charging within an ESP by explicitly calculating both field charging (eq 5) and diffusion charging (eq 6) of particles:

$$\begin{matrix}\begin{matrix}n = [ 1 + 2 \frac{ɛ - 1}{ɛ + 2} ] \frac{E {d}_{p}^{2}}{4 e} & & ( Field charging )\end{matrix} & ( 5 ) \\ \begin{matrix}n = \frac{{d}_{p} kT}{2 {e}^{2}} ln [ 1 + {( \frac{2 π}{{m}_{i} kT} )}^{1 / 2} {d}_{p} {e}^{2} {n}_{i ∞} t ] & & ( Diffusion charging )\end{matrix} & ( 6 )\end{matrix}$$

where n is the number of unit charges on a particle [-], e is the charge of an electron [stC], k is Boltzmann's constant [ergs/K], T is temperature [K], Eₒ is the electric field strength in the channel [stV/cm], ε is the particle dielectric constant (assumed to be very large) [-], mᵢ is the mass of a gaseous ion (assumed to be O₂) [g], t is time [s], and n_{i∞} is the ion density far from the particle [1/cm³]. Field charging of particles is sufficiently rapid that compared to the time scale of the channel flow (L/U₀) it is reasonable to assume the particles attain their field charging saturation charge instantaneously; thus, eq 5 represents this saturation charge due to field charging for particles of diameter dₚ. By comparison, diffusion charging occurs more slowly, necessitating the use of an average value over the 3.3-second residence time of the channel. The total particle charge is the sum of the saturation field charge and the average charge acquired by diffusion over the 3.3-second residence time of the channel, although it has been noted that such additive approaches are generally less accurate than results obtained by numerically modeling the charging process.

The initial, size-specific particle number densities entering the channel decrease exponentially with time according to eq 7, a modified form of the Deutsch-Anderson equation based on the configuration in FIG. 3:
NDₚ(dₚ,t)=ND_{p,0}(dₚ)•exp[−2Uₑₛ(dₚ)•t/H] (7)

where ND_{p,0}(dₚ) and Uₑₛ(dₚ) are the initial number density entering the channel and the terminal electrostatic drift velocity, respectively, of particles of diameter dₚ. H is as defined previously. The model assumes no particle interactions, either electrical or physical. The model does not consider operational losses such as sneakage (particulate-laden flow escaping the shroud through fluid leaks) or rapping reentrainment (resuspension of collected particulate matter during periodic cleaning of collection electrodes) that degrade ESP performance in practice.

The Frössling equation (eq 8) provides a correlation between the mean Sherwood number S̅h̅_̅{̅d̅}̅ about a spherical particle and the particle Reynolds number which depends on the gas-particle slip velocity induced by the particle charge and the electric field. Equating the definition of S̅h̅_̅{̅d̅}̅ to the Frössling equation (eq 8), the mean convective mass transfer coefficient h̅ₘ̅ can be found once the molecular diffusivity D_{ab} of the Hg⁰-air system as determined via an expression (eq 9):

$$\begin{matrix}\overline{{Sh}_{d}} = \frac{\overline{{h}_{m}} {d}_{p}}{{D}_{ab}} = 2 + 0.552 {Re}_{d}^{1 / 2} {Sc}^{1 / 3} & ( 8 ) \\ {D}_{ab} = \frac{1.858 {e}^{- 27} {T}^{3 / 2}}{P {σ}_{ab}^{2} {Ω}_{D}} {( \frac{1}{{M}_{a}} + \frac{1}{{M}_{b}} )}^{1 / 2} & ( 9 )\end{matrix}$$

in which P is pressure [atmospheres], T is temperature [K], Mₓ is molecular weight of species x [g/gmol], σ_{ab} is the average collision diameter for species a and b [m], and Ω_{D} is the collision integral [-]. Values for σ and Ω_{D} originate from the Lennard-Jones 6-12 potential.

For a polydisperse suspension of particles, consider a subset of particles of diameter dₚ whose number density is NDₚ(dₚ). Equation 10 represents the cumulative convective mass transfer rate of Hg⁰ to particles of diameter dₚ contained within a differential fluid volume ΔV of height H/2, differential length Δx, and unit depth (see FIG. 3). Because the particles are of uniform size, they exhibit identical charge (equal to the sum of eq. 5 and 6) and thus have the same charge-driven gas-particle slip velocity Uₑₛ. Note that the assumption of a uniform value of Uₑₛ yields a uniform value of h̅ₘ̅ for all particles of diameter dₚ:
\dot{M}_{Hg}(dₚ,t)= h̅ₘ̅(dₚ)NDₚ(dₚ)ΔV•4π(dₚ/2)²ρ(C_{Hg}(t)−0) (10)

The number density of particles of diameter dₚ is determined from the total particle mass loading MLₚ (0.1 g/m³ for the present analysis) and the particle size distribution (eq 1). For a log-normal size distribution of specified geometric mean and standard deviation (eq 1), specifying the total particle mass loading MLₚ and assuming a bulk particulate density of 0.45 g/cc (a mean value for both fly ash and powdered activated carbon) yields the size-specific particle number density NDₚ(dₚ). Integrating eq 10 over all sizes dₚ yields the total gas-particle mass transfer rate (eq 11):

$$\begin{matrix}{\dot{M}}_{Hg} ( t ) = {\int }_{0}^{∞} {\dot{M}}_{Hg} ( {d}_{p} , t ) ⅆ ( {d}_{p} ) \\ = {\int }_{0}^{∞} \overline{{h}_{m}} ( {d}_{p} ) {ND}_{p} ( {d}_{p} ) Δ V \cdot 4 {π ( \frac{{d}_{p}}{2} )}^{2} ρ ( {C}_{Hg} ( t ) - 0 ) ⅆ ( {d}_{p} )\end{matrix} \qquad ( 11 )$$

Finite difference integration of eq 11 for a specified particle size distribution yields the total rate of gas-particle mass transfer as a function of time, which is linked by a mass balance to the rate of change of the Hg⁰ concentration in a differential volume of fluid ΔV (eq 12):

$$ρ Δ V \frac{\partial {C}_{Hg}}{\partial t} = - {\dot{M}}_{Hg} ( t ) \qquad ( 12 )$$

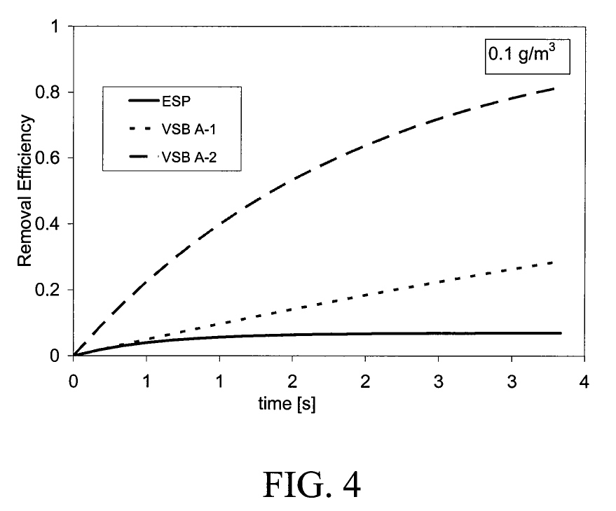

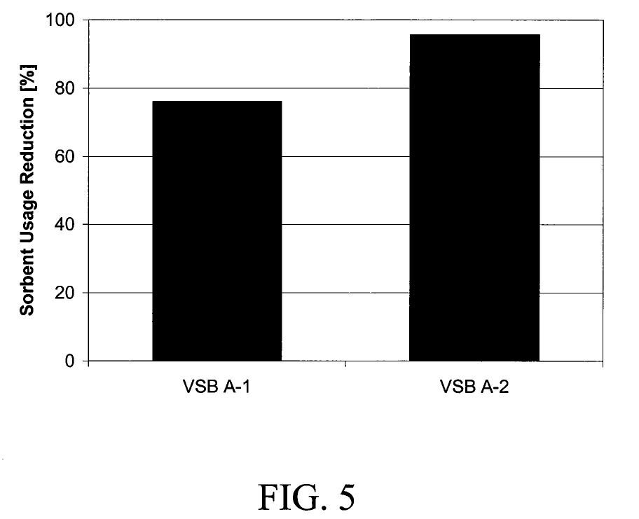

FIGS. 4 and 5 show the predicted performance of a VSB configuration each at two different operating points (A1 and A2), where the particulate phase is a monodisperse aerosol of 30-μm spherical particles. The mass transfer enhancement factors at the operating points (A1) and (A2) are taken directly from related studies. FIG. 4 clearly shows the effect of the increase in gas-particle mass transfer induced by the AC field of the VSB process on gas-particle mass transfer (or, as alternatively presented in FIG. 5, the effect on sorbent usage required to achieve a specified removal efficiency). These results assume the particulate phase acts as a perfect mercury sink (infinite reactivity and Hg adsorption capacity).

Particles smaller than 30 micrometers would yield better performance than that presented in FIG. 4, as has been demonstrated for conventional ESPs in numerical modeling and pilot and full-scale testing. The particle mass loading of 0.1 g/m³ used in FIG. 4 is a representative value for conventional sorbent injection. For situations where the native fly ash exhibits substantial Hg adsorption capacity, mass loadings of 1-10 g/m³ would be more representative. In this way, VSBs present an opportunity to increase gas-particle mass transfer, and thus rates of mercury adsorption and/or heterogeneous oxidation, whether the particulate phase is an injected sorbent (of any type or chemical composition) or native fly ash.

The results (FIGS. 4 and 5) show the VSB-A configuration yields superior performance than a conventional ESP alone. Where the AC electrode and the DC electrodes are spatially separated and occur sequentially, the VSB stage operates with a constant particle mass loading. Such a configuration would be applicable to sites where the preexisting ESP has multiple fields, thereby allowing one field to be reconfigured for VSB operation. Note that high VSB performance allows use of larger particle sizes (30 μm) that are much more easily removed in downstream ESP fields than the finer particle sizes that typically are needed to achieve the same mercury removal efficiency at the same particle mass loading.

It should be appreciated that the beneficial characteristics of alternative embodiments of the VSB system can be extended to many other processes involving mass transfer between a flowing gas and a solid material. For example, catalytic gas treatment processes often employ large, unwieldy, solid catalyst monoliths. In order to maximize gas-solid mass transfer, these monoliths often take the form of high surface area honeycomb structures. Although such structures present a very large surface area for mass transfer, they also induce a large pressure drop within the gas flow. A VSB system would provide equal or greater surface area for mass transfer without any induced pressure drop in the gas stream.

As previous discussed, the performance of the VSB can be measured in terms of adsorption efficiency. Adsorption efficiency is defined as the percentage of initial sorbent that is adsorbed during the VSB process. Extractive measurements of the sorbate concentration downstream of the VSB, in combination with the known initial sorbate concentration of the gas stream entering the VSB, yields the absorption efficiency. The experimental test matrix provides the necessary data to correlate VSB performance with gas temperature, moisture content, and velocity; sorbent charge and mass injection rate; electrostatic drift-to-freestream velocity ratios; and AC voltage and frequency.

By way of example and not by limitation, the following additional embodiments of the VSB system 20 are contemplated.

In an embodiment, any suitable powdered catalysts such as titanium and vanadium could be introduced into the gas stream through the powdered solid material introducing mechanism. For example, the powdered catalysts can facilitate the use of the VSB system 20 to remove nitrogen oxides from waste gas streams. One or more liquid injectors could be used to disperse ammonia into the gas stream. Preferably, the liquid injectors should be placed upstream of the charged electrodes a distance sufficient to assure a largely uniform ammonia distribution within the gas stream at the charged electrodes.

In another embodiment, several VSBs could be placed in series with each VSB facilitating the removal of different trace gas species.

In an alternative embodiment, the VSB system 20 could facilitate the increase of mass transfer between trace gas species and powdered solid material if the solid material were introduced in bulk and charged with a corona as is typical in electrostatic precipitators.

In an embodiment, the VSB system 20 could facilitate the increase of mass transfer between trace gas species and powdered solid material if the solid material were formed or precipitated in situ upstream of the VSB system 20. For example, a particle could be formed in situ by condensing a vapor by precipitation or as a by-product of a combustion process. The solid material formed in situ could then pass over a charged corona as is typical in electrostatic precipitators.

In another embodiment, the VSB system 20 could be used as part of an integrated system for detecting chemical and biological warfare (CBW) agents. For example, impedance-based electrochemical sensors detect the presence of CBW agents by measuring the change in impedance of a thin film of water. Biomolecular recognition technology has previously suffered from several perceived shortcomings. The fact that biomolecules operate only in aqueous environments previously made biosensors unsuitable for detecting species in the gas phase. Low analyte concentrations slowed detection due to their effects on the kinetics of specific biomolecular recognition interactions. Such characteristics severely limited transfer of biosensor technology to practical applications.

The VSB system 20 overcomes these obstacles. Using an embodiment of the VSB system 20, the CBW agent is transferred to the liquid phase by a novel, enhanced mass transfer process. The ability to rapidly and efficiently transfer a gas-phase analyte to the liquid phase is a major advance over competing technology.

To detect airborne threats, aqueous phase detection devices must necessarily transfer the analyte from the gas phase of the sampled air stream to the aqueous film. Conventional gas chromatography relies on gaseous diffusion to affect this mass transfer process. However, because Fickian gas diffusion rates are proportional to the concentration gradient, diffusive mass transfer rates are extremely slow for trace analyte concentrations, such as would be expected for CBW agents. Bench-top gas chromatography addresses this issue by using long, narrow-bore tubes to provide long residence times and short diffusion distances. Such features are impractical if compact packaging, high throughput, low power consumption, and near-real-time detection are desired.

In an embodiment, the VSB system 20 is well-suited for such challenging gas-liquid mass transfer tasks. For example, the VSB system 20 is capable of removing part-per-billion concentrations of elemental mercury from coal combustion exhaust gases. In another embodiment, the VSB system 20 introduces a charged aerosol sorbent into the target gas stream. The suspended aerosol is then preferably subjected to an AC electric field and a DC electric field. Adapting the VSB system 20 for highly efficient gas separation for CBW agent detection holds significant promise. In an embodiment, the VSB system 20 is adapted for CBW agent detection might use a liquid aerosol of atomized water droplets. Further, in an alternative embodiment, the VSB system 20 uses electric fields to manipulate charged aerosols offering exceptional opportunities for miniaturization. Because electric field strength varies inversely with characteristic dimension, the miniaturization desired of Micro Gas Analyzers will reduce the voltage requirements and power consumption associated with the VSB system 20.

In an embodiment, the VSB system 20 may be adapted for use with an aqueous phase detection device. For example, a gas stream extracted from the monitored volume of air first undergoes humidification by injecting a simple water mist from a prior art flush-mounted piezoelectric atomizer. Such piezoelectric atomizers are commonly found in household air humidifiers and easily produce fine mists of droplets with diameters on the order of 10 μm. The production of so many droplets of such small size provides a tremendous total surface area for adsorption of the analyte. As the mist evaporates, the gas stream becomes nearly saturated with water vapor (relative humidity ˜100%). After the humidification process, a second array of piezoelectric atomizers injects a fine mist of charged water droplets. These charged droplets do not evaporate in the nearly saturated (water vapor) gas stream. These charged water droplets adsorb species from the gas-phase as they trace a sinuous path across the gas stream, drawn by the AC and DC electric fields. After traversing the gas stream, the charged droplets impact the grounded plate electrode, lose their charge, and are collected. The collected, uncharged liquid is then directed to the aqueous phase detection device for detection and discrimination of CBW agents.

In an embodiment, the VSB system 20 exposes the gas to the exceptionally large surface area of the suspended aerosol. The three-dimensional motion induced in the dispersed phase by the electric fields insures a continuous high relative velocity between the two phases even as the aerosol is entrained in the gas flow. The product of the interphase relative velocity (m/s) and the exceptionally large adsorption surface area of the aerosol (m²) yield a very high swept volume rate (m³/s) that has a first-order effect on adsorption rate. The VSB system 20 preferably provides compact, low power mass transfer. Because the gas chromatographic approach of small bore columns is not used, VSBs present negligible additional pressure drop within the gas flow. The two electric fields consume little power due to the small flow of current between the electrodes, and the required voltage can be attained using solid state transformers. The VSB system 20 as described is well-suited for passive and nearly maintenance-free operation, only requiring electric power and a small supply of water for humidification. The water flows, electrostatic voltages and frequencies are all variable, allowing the system to be programmed to respond in real time to detection events.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A system comprising:
at least one outlet for introducing a material into a gas stream;
at least one charged AC electrode sequentially followed by at least a first charged DC electrode and at least a second charged DC electrode, the charged AC electrode generating a first electric field that imparts a motion to the material, the first charged DC electrode and the second charged DC electrode cooperatively generating a second electric field that imparts a drift velocity to the material.

2. The system of claim 1, wherein the material is electrically charged prior to entering the gas stream.

3. The system of claim 1, wherein the first charged DC electrode and the second charged DC electrode have a different voltage.

4. The system of claim 1, wherein the second charged DC electrode has voltage of 0 and is grounded.

5. The system of claim 1, wherein the second charged DC electrode comprises a plate so constructed and arranged for collecting the material.

6. The system of claim 1, wherein each charged AC electrode is oriented substantially peripheral to the gas stream and normal to the flow of the gas stream, each charged AC electrode generating an electric field that imparts motion to the material.

7. The system of claim 1, wherein the at least one outlet comprises a plurality of outlets that are stacked.

8. The system of claim 1, wherein the at least one outlet comprises a plurality of outlets that are in series along the gas stream.

9. The system of claim 1, wherein the motion is periodic.

10. The system of claim 1, wherein the material is selected from the group consisting of a solid material, a liquid material, a powdered material, an aerosol, a sorbent, a catalyst and combinations thereof.

11. The system of claim 1, wherein the material is capable of receiving a contaminant from the gas stream.

12. The system of claim 1, wherein the outlet is located upstream of the charged AC electrode.

13. The system of claim 1, wherein the outlet is constructed and arranged for injecting a liquid into the gas stream.

14. The system of claim 13, wherein the injected liquid is selected from the group consisting of an ammonia solution, a urea solution, an aerosol and combinations thereof.

15. The system of claim 1, wherein the material is capable of receiving a plurality of contaminants from the gas stream.

16. The system of claim 1, wherein the material is electrically charged prior to entering the gas stream.

17. A system comprising:
at least one outlet for introducing a material into a gas stream, wherein the material is capable of receiving a contaminant from the gas stream; and
at least one charged AC electrode, the charged AC electrode generating a second electric field that imparts additional motion to the material.

18. The system of claim 17, wherein the charged AC electrode is sequentially followed by a filter.

19. The system of claim 18, wherein the filter is selected from the group consisting of fabric filter, cyclone, wet scrubber and combinations thereof.

20. A system for manipulating a material, the system comprising at least one charged AC electrode sequentially followed by at least a first charged DC electrode and at least a second charged DC electrode, the charged AC electrode generating a first electric field that imparts a motion to the material, the first charged DC electrode and the second charged DC electrode cooperatively generating a second electric field that imparts a drift velocity to the material.

21. A virtual sorbent bed system for removing a contaminant from a gas stream, the system comprising:
a plurality of charged AC electrodes oriented substantially peripheral to the gas stream and normal to the flow of the gas stream, the plurality of charged AC electrodes generating a first electric field that imparts three-dimensional motion to the contaminant;
a positively charged DC electrode located downstream of the AC electrodes, the positively charged DC outlets oriented substantially peripheral to the gas stream and normal to the flow of the gas stream;
a negatively charged DC electrode located downstream of the positively charged DC electrode and oriented substantially peripheral to the gas stream and normal to the flow of the gas stream, the positively charged DC electrode and the negatively charged DC electrode cooperatively generating a second electric field that imparts a drift velocity to the contaminant.

22. A method for receiving a contaminant from a gas stream, the method comprising:
introducing a material into the gas stream through at least one outlet, wherein the material is capable of receiving the contaminant from the gas stream;
generating a first electric field from at least one charged AC electrode, wherein the first electric field imparts motion to the material; and
generating a second electric field from at least a first charged DC electrode and at least a second charged DC electrode, the second electric field imparting a drift velocity to the material, wherein the first charged DC electrode and the second charged DC electrode are located downstream of the charged AC electrode.

23. The method of claim 22, further comprising receiving and collecting the material after the material has removed the contaminant from the gas stream.

24. The system of claim 22, wherein the material is electrically charged prior to entering the gas stream.

25. The method of claim 22, wherein the material is selected from the group consisting of a solid material, a liquid material, a powdered material, an aerosol, a sorbent, a catalyst and combinations thereof.

26. A method for receiving a contaminant from a gas stream, the method comprising:
introducing a material into the gas stream through at least one outlet, wherein the material is capable of receiving the contaminant from the gas stream;
generating a first electric field from at least one charged AC electrode, wherein the first electric field imparts motion to the material; and
providing a filter to receive the material.
